(19) United States
(12) Patent Application Publication
(10) Pub. No.: US 2007/0172802 A1
(43) Pub. Date: Jul. 26, 2007

(54) Portable early learning sensory toy set for babies and infants

(76) Inventors: Stephanie Adams, Harpers Ferry, WV (US); Stephanie MacMillan, Leesburg, VA (US)

Correspondence Address: LYTLE PATENT SERVICES, LLC, 18582 MERLON COURT, LEESBURG, VA, 20176, US

(21) Appl. No.: 11/657,001

(22) Filed: Jan. 24, 2007

Related U.S. Application Data
(60) Provisional application No. 60/761,790, filed on Jan. 25, 2006.

(51) Int. Cl. G09B 19/00

(52) U.S. Cl. 434/247; 434/236

(57) ABSTRACT

A portable early learning sensory system configured to aid the development of a child through interaction with a caregiver and to provide the caregiver with an explanation regarding the use of the objects in system to illicit developmentally appropriate responses from the child. The portable early learning sensory system includes tactile learning components, visual learning components, auditory learning components, and caregiver assistance guides associated with each learning component. The caregiver assistance guides contain information on how to use the learning components effectively with the child in order to illicit the developmentally appropriate response from the child, developmental milestones, and safety information.

### CROSS REFERENCE TO RELATED APPLICATION

The present application contains subject matter related to that disclosed in commonly assigned U.S. patent Application Ser. No. 60/761,790, filed Dec. 25, 2006, entitled PORTABLE EARLY LEARNING SENSORY TOY SET FOR INFANTS AGES 0-3 MONTHS AND BEYOND, the contents of which is hereby incorporated by reference in its entirety.

### BACKGROUND OF THE INVENTION

1. Field of the Invention

The present invention relates to mechanisms for assisting caregivers in providing developmentally appropriate toys and corresponding activities for new born babies and infants.

2. Discussion of the Related Art

Raising a baby is a time filled with great excitement. New caregivers have many things to experience and learn when they bring their baby home: how to bathe their baby, change their baby, comfort their baby, etc. New caregivers can be easily overwhelmed with all of their new responsibilities. Along with everything else they have to learn, caregivers also benefit from understanding how to play with their baby effectively and appropriately. It is a common misconception that newborns only need to eat, sleep, have their diaper changed and be loved. Research has shown that the first six months of life is an important time for developing skills essential for learning. During these early months infants are taking in their environment and developing early learning skills essential for cognitive, motor, and emotional development.

### SUMMARY OF THE INVENTION

The Portable Early Learning Sensory Toy Set for Babies and Infants not only provides caregivers with appropriate toys for the early months but it helps caregivers understand how to use these toys effectively to play with their babies as well. Understanding how to play with their baby and having developmental toys can help increase interaction and lead to essential early bonding opportunities between caregivers and baby.

The Portable Early Learning Sensory Toy Set for Babies and Infants is a unique item because it involves a group of developmentally appropriate toys for new born babies, infants, and beyond. This kit of toys is designed to address the play needs of a newborn baby according to the skills being developed at early ages. The kit also contains information for caregivers concerning how to use these toys effectively with their baby to illicit an appropriate play and learning environment. It eases the unfamiliar and uncomfortable feeling many caregivers face when trying to play with a new baby and being unsure of whether their activity is at the child's level or not. It also provides knowledgeable and experienced caregivers with easy and fun toys to use with their baby and fin activities to try. Babies benefit from this product because of the interaction they will receive from their caregivers and the involvement they will receive with developmentally appropriate and stimulating toys and activities. Housed in the Portable Early Learning Sensory Toy Set for Babies and Infants is all of the information needed to use the product effectively to optimize development and enrich the senses.

The Portable Early Learning Sensory Toy Set for Babies and Infants contains toys, activity ideas to address developmental skills, and safety information. Developmental skills associated with the toys and activities focus on visual perception, hand eye coordination, fine motor skills, gross motor skills, and sensory skills. The toys contained in Portable Early Learning Sensory Toy Set for Babies and Infants include a cloth rattle, book mobile, accordion mirror, plastic rattle, sensory mat(s), sensory mitten(s)/glove(s), stay-in-place mat, visual glove, and pattern sheet(s), as well as a toy activity booklet to help caregivers understand how to use the toys effectively and appropriately.

The toy activity booklet is a collection of all the activity pages for each toy. The toy activity booklet is available in at least one of a permanently bound arrangement or an attachable/detachable arrangement whereby each activity page of the activity booklet is configured to be separable from a common binding and configured to be joined into the common binding. Each toy is described on an individual activity page in the activity booklet. Each activity page includes three main sections: (i) a list of at least four fun and developmentally appropriate activities associated with the toy, (ii) information regarding the importance the role of the toy has on development and the developmental skills the toy is addressing, and (iii) safety warnings, developmental milestones, and other information relevant to the toy, child, and caregiver. The fun and developmentally appropriate activities are arranged in an order to help the caregivers understand an appropriate age range for the activity. In a non-limiting example, visual tracking activities are presented as developmentally appropriate skills for infants 0-6 months, 2-6 months, and 3-6 months.

### BRIEF DESCRIPTION OF THE DRAWINGS

FIG. 1 is a front view of a cloth rattle according to an aspect of the present invention;

FIG. 2 is a back view of a cloth rattle according to an aspect of the present invention.

FIG. 3 is a detailed view of a securing device according to an aspect of the present invention.

FIG. 4 is a front view of a page of a cloth book mobile according to an aspect of the present invention.

FIG. 5 is a back view of the page of a book mobile according to an aspect of the present invention.

FIG. 6 is a book view of the book mobile of FIG. 4.

FIG. 7 is a mobile view of the book mobile of FIG. 4

FIG. 8 is a front view of a page of a cloth book mobile according to an aspect of the present invention.

FIG. 9 is a back view of a page of a book mobile according to an aspect of the present invention.

FIG. 10 is a front view of a child safe mirror according to an aspect of the present invention.

FIG. 11 is a perspective view of the child safe mirror according to an aspect of the present invention.

FIG. 12 is a back view of the child safe mirror according to an aspect of the 30 present invention.

FIG. 13 is a front view of a sensory mitten according to an aspect of the present invention.

FIG. 14 is a back view of the sensory mitten according to an aspect of the present invention.

FIG. 15 is a front view of an outer circular rattle ring according to an aspect of the present invention.

FIG. 16 is a detailed view of an attachable/detachable rattle according to an aspect of the present invention.

FIG. 17 is a detailed view of a smaller moon-shaped rattle detachable attached to the outer circular rattle according to an aspect of the present invention.

FIG. 18 is a detailed view of a smaller sun-shaped rattle detachable attached to the outer circular rattle according to an aspect of the present invention.

FIG. 19 is a detailed view of a smaller star-shaped rattle detachable attached to the outer circular rattle according to an aspect of the present invention.

FIG. 20 is a front view of a sensory mat according to an aspect of the present invention.

FIG. 21 is a back view of the sensory mat according to an aspect of the present invention.

FIG. 22 is a front view of a stay in place mat according to an aspect of the present invention.

FIG. 23 is a front view of a visual glove according to an aspect of the present invention.

FIG. 24 is a back view of a finger object for the visual glove according to an aspect of the present invention.

FIG. 25 is a front view of a pattern sheet according to an aspect of the present invention.

FIG. 26 is a front view of an activity page according to an aspect of the present invention.

### DETAILED DESCRIPTION OF THE INVENTION

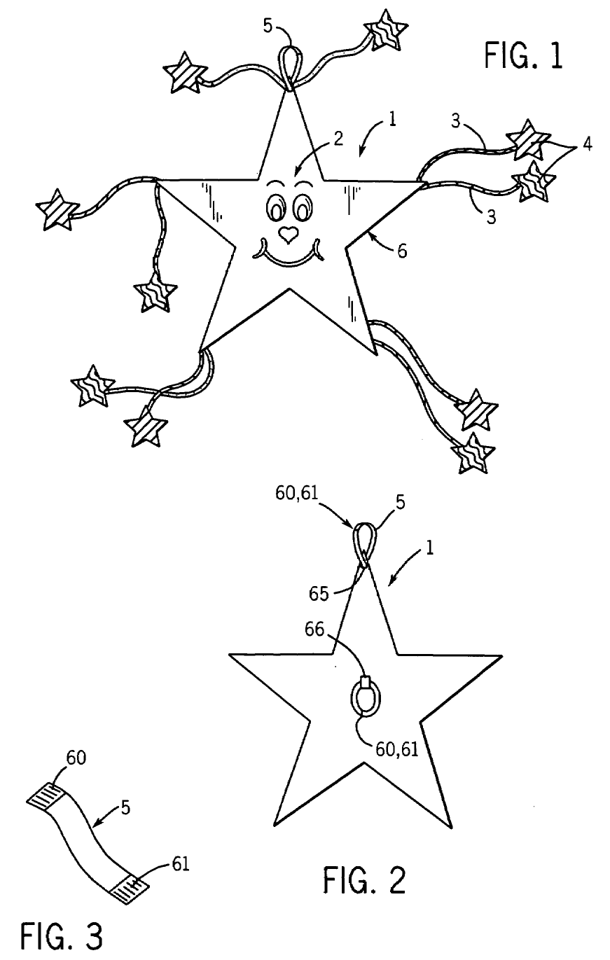

FIG. 1 shows a front view of a cloth rattle 1 according to the present invention, in which the cloth rattle 1 is in a shape of a star. The cloth rattle 1 is at least the colors black, white, or red, and includes a facial expression 2. A non-limiting example in FIG. 1 illustrates the facial expression 2 as a smiley face. Features of the facial expression 2 include eyes, eyebrows, a nose, and a mouth. These features are made from fabrics including but not limited to felt, velour, terrycloth, or velvet. The outer contour 6 of the cloth rattle 1 has at least one dangle 3. The at least one dangle 3 is made from patterned, crinkly, elastic materials. The additional tactile objects 4 are made from a variety of materials to stimulate tactile and visual senses. The materials include at least one felt, velour, or velvet and are visually stimulating patterned materials.

A non-limiting example in FIG. 1 illustrates the additional tactile objects 4 are in the shape of stars.

In an another embodiment of the present invention, the additional tactile objects 4 include auditory devices such as bells, beads, and/or chimes, for auditory enjoyment and to provide the caregiver an opportunity to observe the child's ability to hear sounds. It is important to note that this is not an auditory diagnostic device. If the caregiver has any questions or concerns the child's pediatrician should be notified immediately.

The cloth rattle 1 is at least four inches in height and at least four inches in width. The at least one dangle 3 is at least two inches in length and at least one fourth inches in width. The additional tactile objects 4 are at least one inch in width, are at least one inch in height, and are at least one inch in depth.

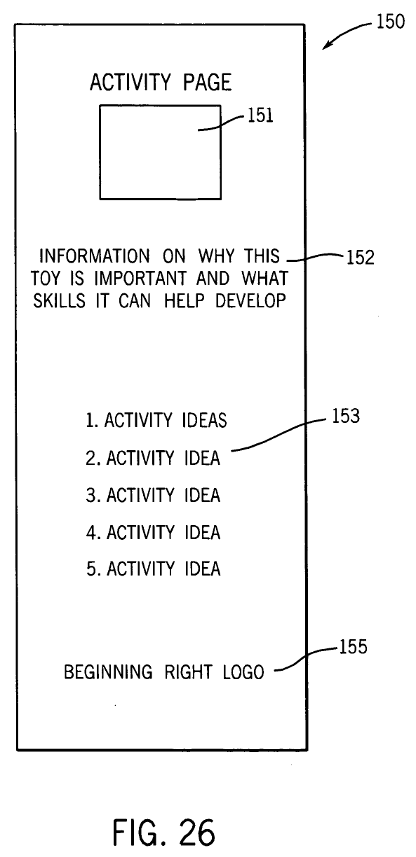

Associated with the cloth rattle 1 is an activity page, like that shown in FIG. 26. The activity page contains a descriptive title, which associates the page with the cloth rattle 1. The content of the activity page contains three main sections: (i) information on why the toy is important for development and what skills it can help emphasize with the infant, (ii) a listing of activity ideas, and (iii) safety warnings, developmental milestones, and other information relevant to the cloth rattle.

Exemplary text for the cloth rattle's activity page follows

Star Rattle

Star Rattle Activity Card
1. While on your lap or on a blanket on the floor, move the rattle from one side of the baby's head very slowly and allow the baby to track the rattle with his eyes. Move the rattle back to the middle and then try to get the baby to turn his head to the other side. (0-2 months)
2. Lie your baby on the floor on a blanket. Place the rattle approximately 12 inches from the face. Describe the colors, texture, and object to them. “Look at the red star.” “It feels very soft on our fingers.” (0-3 months)
3. Place your baby on the tummy. Dangle the rattle to one side of their head and try to encourage them to lift the heads. Make sure your praise them for any attempt to lift their heads by saying in a higher pitched voice, “Good job, look at my baby. He's lifting his head. Yeah.” (0-3 months)
4. Place the rattle on their carrier or jungle gym. Give them some time to explore the rattle on their own by just looking at it. (0-4 months)
5. For a sensory experience, take the dangle part of the rattle and run the dangles over the head, face, arms, belly, legs, and feet. Tell the baby what body part the rattle is touching. (0-6 months)
6. Lie down with them next to their carrier or jungle gym and encourage them to touch the rattle. Take their hands and touch the rattle. Describe the texture, color to them while you do this. (0-5 months)
7. Sing “Twinkle, twinkle” to them while you hold the rattle.

SAFETY::

Do not leave your baby alone with any of these objects to play with.

This is a supervised play activity only.

The activities provided with the cloth rattle are intended to emphasize development for infants in motor, visual discrimination, sensory skills, and auditory stimulation.

These activities included in the cloth rattle cards are intended to emphasize the infant's abilities to visually discriminate objects in his/her environment. Infants initially are attracted to bold complex patterns and typically can see best the colors of black, white, and red due to poor color vision and retinal immaturity. Because of this immaturity, the cloth rattle will provide the infant with the colors in which they respond to best at this developmental stage. The graphic, bold pattern of the dangles from the rattle will capture their attention and help the child to emphasize their emerging visual tracking skills. These dangles also provide a needed sensory experience for the infant, since typically infants sense of touch is much more developed at this early stage than any other sense. Because the rattle comes with attachment hooks, this provides the caregiver with options for placement of the rattle within the child's environment (for example: above their heads on a activity gym, placed on the mirror, or stay in place mat). By providing caregivers with options for play either hand held or placed on another surface, this rattle will help the infant practice their emerging motor skills. The rattle is intended to be used in combination with the stay in place mat provided or the adjustable accordion mirror for placement options. Due to these numerous options of uses with the rattle, the infant will have the ability to practice motor skills through reaching, grasping the rattle, moving their head towards the rattle, etc. The rattle can also help to emphasize the development of auditory stimulation for the infant since each dangle includes an auditory device such as bells, beads, and/or chimes to ensure auditory enjoyment for the infant.

FIG. 2 shows a back view of the cloth rattle 1 with at least two securing devices 5. The at least two securing devices 5 are used to attach the cloth rattle to other devices provided by the end user such as activity rings and activity gyms. At the appropriate developmental stage of the infant, the caregiver will be instructed to provide a full frontal view of the cloth rattle 1 to the infant with the infant either lying prone or sitting up. The position of the cloth rattle will be determined by the use of one of the at least two securing devices. The securing device is designed to connect one end 60 of the securing device 5 to the opposite end 61 of the securing device to create a fabric loop that can easily be attached and detached from other user provided objects. One of the at least two securing devices 5 is permanently attached to a top portion 65 of the cloth rattle 1. One of the at least two securing devices 5 is permanently attached to a mid portion 66 of the cloth rattle 1.

FIG. 3 shows a detailed view of the securing device 5. The securing device is a long piece of fabric at least 5 inches in length and ½ inch in width. At one end of the long piece of fabric 60 is a hook and loop type material. At an opposite end 61 is a mating loop and hook type fabric. The securing device is designed to connect one end 60 of the securing device 5 to the opposite end 61 of the securing device to create a fabric loop that can easily be attached and detached from other user provided objects. One of the at least two securing devices 5 is permanently attached to a top portion 65 of the cloth rattle 1. One of the at least two securing devices 5 is permanently attached to a mid portion 66 of the cloth rattle 1.

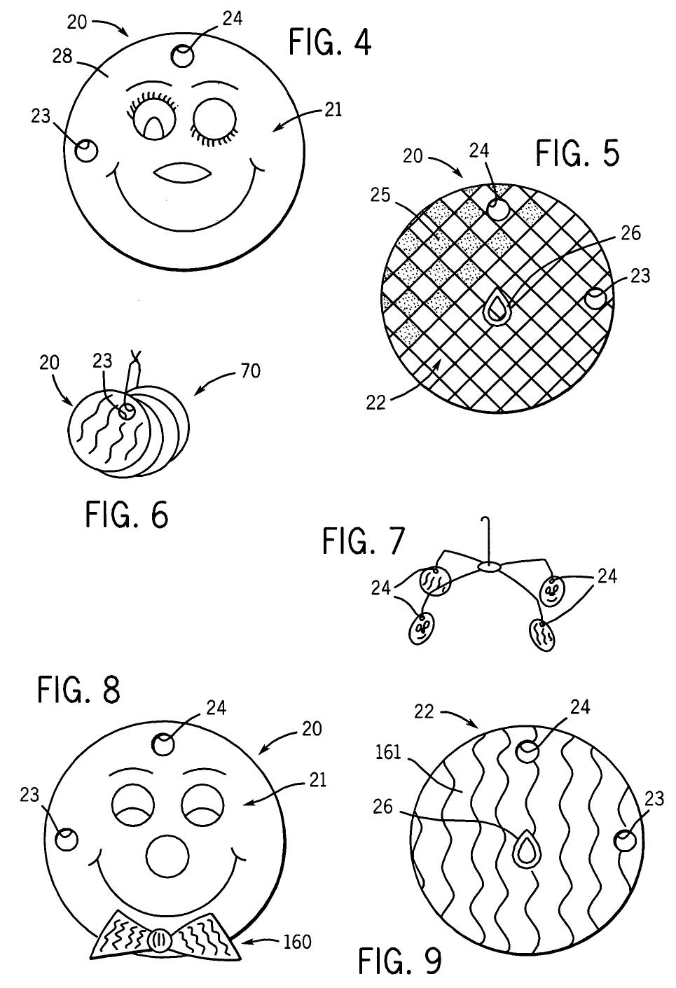

FIG. 4 is a front view 28 of a page 20 of a configurable cloth book mobile according to the present invention. The front view of the page 20 includes an image of an abstract face 21. In a non-limiting example, FIG. 4 illustrates a happy expression for the abstract face 21. Other expressions include but are not limited to excited, surprised, silly, and joyful. The front view of the page 20 is in black and white. Additional colors are added to the front view of the page 20 in the following order: red, green, blue, yellow, orange, and purple. The image of the abstract face 21 is made from materials that include but are not limited to yarn, mirrors, velvet, buttons, beads, rattles, or bells. In a non-limiting example FIG. 4 illustrates the page 20 of the configurable cloth book mobile in the shape of a circle. A securing area 23 is located on a left side of the page 20 of the configurable cloth book mobile. The securing area 23 includes but is not limited to a hole or a tag. A top attachment area 24 is located on a top side of the page 20 of the configurable cloth book mobile.

FIG. 5 is a back view 22 of a page 20 of the configurable cloth book mobile according to the present invention. The back view 22 of the page 20 has an intricate pattern 25 using identical colors as the front view of the page 20 from FIG. 4. The back view of the page 22 is in black and white. Additional colors are added to the back view of the page 22 in the following order: red, green, blue, yellow, orange, and purple. A non-limiting example FIG. 5 illustrates a bold graphic checker board pattern 25.

In a non-limiting example FIG. 5 illustrates the page 20 of the configurable cloth book mobile in the shape of a circle. The securing area 23 includes but is not limited to a hole or a tag. A top attachment area 24 is located on a top side of the page 20 of the configurable cloth book mobile. A back securing mechanism 26 is at least two and one half inch fabric loop, permanently located on the back of the page 22.

FIG. 6 shows one embodiment of a book 70 which is part of the inventive toy set. The book 70 includes at least four different abstract faces for each page 20 of the configurable cloth book mobile. Each page 20 of the configurable cloth book mobile in the current embodiment as a book 70 is separable from the securing area 23. The securing area 23 will be non-permanently bound using a detachable ribbon, yarn, or some other securing fibrous device, that goes through each securing area 23 of the page 20. This embodiment enables the caregiver to use the book 70 in a conventional manner, or to independently use individual pages of the book for developmental activities such as visual tracking and reaching.

In another embodiment the securing area 23 is used to suspend the page 20 of the configurable cloth book in front of a seated position infant.

In another embodiment the book 70 is permanently bound together.

FIG. 7 shows another embodiment in which the attachment area 24 is used to suspend the page 20 of the configurable cloth book above an infant lying prone on its back.

The page 20 of the configurable cloth book mobile is at least five inches in circumference.

FIG. 8 is a front view of a page 20 of a configurable cloth book mobile according to the present invention. The front view of the page 20 includes an image of an abstract face 21 with an accessory 160. The accessory 160 is not limited to a bowtie. In a non-limiting example, FIG. 8 illustrates a happy expression for the abstract face 21. Other expressions include but are not limited to excited, surprised, silly, and joyful. The front view of the page 20 is in black and white. Additional colors are added to the front view of the page 20 in the following order: red, green, blue, yellow, orange, and purple. The image of the abstract face 21 and the accessory 160 is made from materials that include but are not limited to yarn, mirrors, velvet, buttons, fabrics, and beads. The image of the abstract face 21 also includes but is not limited to sound devices such as rattles and bells. In a non-limiting example FIG. 8 illustrates the page 20 of the configurable cloth book mobile in the shape of a circle. A securing area 23 is located on a left side of the page 20 of the configurable cloth book mobile. The securing area 23 includes but is not limited to a hole or a tag. A top attachment area 24 is located on a top side of the page 20 of the configurable cloth book mobile.

FIG. 9 is a back view of the page 22 of the configurable cloth book mobile according to the present invention. The back view of the page 22 has an intricate pattern 161 using identical colors as the front view of the page 20 from FIG. 8. The back view of the page 22 is in black and white. Additional colors are added to the back view of the page 22 in the following order: red, green, blue, yellow, orange, and purple. A non-limiting example FIG. 9 illustrates a non-standard pattern.

In a non-limiting example FIG. 9 illustrates the page 20 of the configurable cloth book mobile in the shape of a circle. The securing area 23 includes but is not limited to a hole or a tag. A top attachment area 24 is located on a top side of the page 20 of the configurable cloth book mobile. A back securing mechanism 26 is at least one and one half inch fabric loop, permanently located on the back of the page 22.

Associated with the configurable cloth book mobile is an activity page, like that shown in FIG. 26. The activity page contains a descriptive title, which associates the page with the configurable cloth book. The content of the activity page contains three main sections: (i) a list of fun and developmentally appropriate activities associated with the configurable cloth book, (ii) information regarding the important role the configurable cloth book has on development and the developmental skills being addressed, and (iii) safety warnings, developmental milestones, and other information relevant to the configurable cloth book.

Exemplary text for the configurable cloth book's activity page is

Book Mobile

Book Mobile Activity Card
1. With your baby on a blanket on the floor, remove one page of the book and bring it close to the baby's face. (Approximately 8 to 10 inches from the face.) Let your baby focus on the page and then gradually move the page slowly to one side of their head. It will take a while for the baby eyes to follow the page. (Newborns sight is not completely developed and they tend to track items in a jerky fashion.) You can use the patterned side of the page or the face side. See which side your baby responds to best. Then gradually move the page back to the center as your baby follows with their eyes and then move it to the opposite side of their head. (0-2 months)
2. With your baby on the floor, insert a page of the book into the vinyl pocket attachment of the break resistant child reflective surface, or prop a page of the book on the base of the furniture or wall, to have the page next to them as they are having some free time on the floor. (0-3 months)

3. Sit your child on your lap with their backs resting against your chest and look at each page of the book. Bring their hands forward to stretch out their arms some to try to reach towards the sensory parts of the book. Or you can bring the book right to their hands so they can experience the book. (0-4 months)
4. Remove the individual pages and hang them on the mobile arms or hang them on an activity gym using activity rings. The pages could also hang from a pack and play, car seat handle or stroller. When the baby is smaller, use the securing loop on the back of the page. When they have better mobility and can move their heads more, use the securing ring on the top of each page. (0-4 months)
5. While your child is resting in your arms, or lap, describe each page to your child, for example, “Look at the red nose. Feel the soft hair.” (0-6 months and beyond)
6. As your baby grows and develops more ability to use his hands and fingers, get him to manipulate the pages. Allow him to turn the pages of the book, play with the facial features, etc. (4-6 months)
7. Play silly games with the individual faces of the book. Lay them on the floor or on the stay in place mat. Have them available for your baby to roll toward, crawl to, etc. Wave to the faces; hide them under a blanket or behind something easily accessible to the baby. Have the baby look for them. (4-6 months and beyond)

Safety Warning:
Please make sure to never leave your child unsupervised during any of these activities listed above. These activities are meant to have an adult present at all times.

Important Development and Developmental Milestones
The activities included with the book mobile are intended to emphasize development in early language, visual discrimination, social emotional, gross motor, fine motor, and tracking skills for the newborn baby.

The activities included in the book mobile cards are intended to emphasize the infant's abilities to visually discriminate objects in his environment. Infants are initially attracted to bold complex patterns and typically can see best the colors of black, white, and red due to poor color vision and retinal immaturity. Because of this immaturity, the book will provide the infant with bold and intricate patterns in the colors in which they respond to best at this developmental stage. Infants also have preferences for the human face or face like objects. The book mobile pages include pages of very interesting faces done in bold graphic patterns with geometric, intricate patterns on the back, and raised surfaces. By providing the infant with the correct colors and patterns for this stage of development, we will hope to encourage curiosity and concentration in the infant. The book's activities also include the involvement of the caregiver, which is essential to early bonding important in the development of social emotional skills in the infant. Activities that involve the caregiver reading to the infant will help to encourage the very early building blocks of language for the infant through hearing their caregivers talk. The book's ability to turn into a mobile will allow the infant the ability to emphasize their development in their motor skills for reaching and kicking. By placing one page onto an activity gym the child will be able to work on skills in motor development by trying to reach or kick for the page. Also the caregiver has the option to work with the baby by isolating one page of the book at a time and slowly move it around to help the infant to work on visual tracking skills.

When used individually, the pages can be positioned so baby can see more clearly laying on their back or being propped up as well. It also allows caregivers to provide independent learning and play time for their child when they use it this way as well.

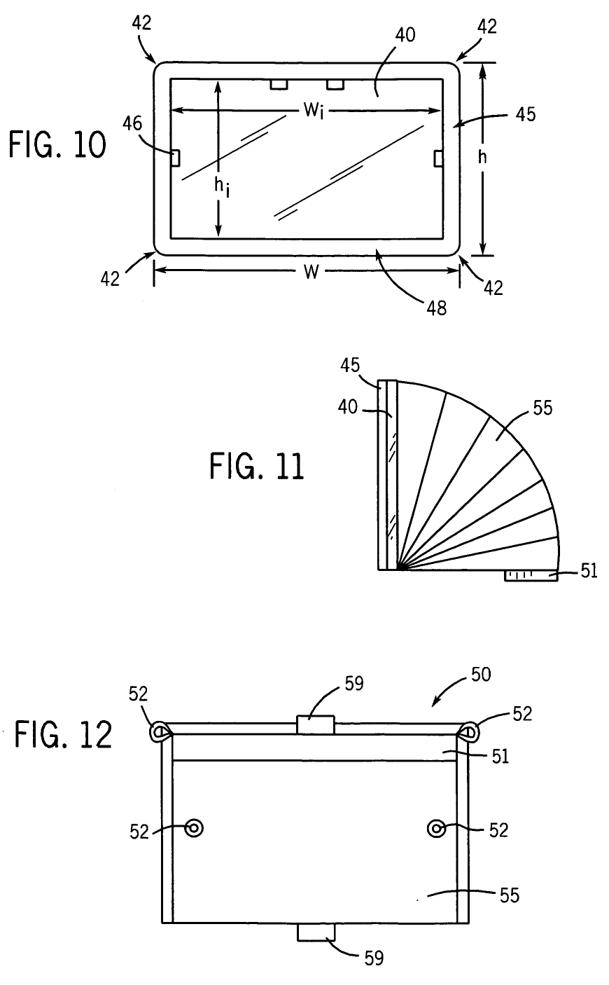

FIG. 10 is a front view of a child safe break resistant reflective surface 40 having a height h at least 6 inches, having a width w at least 7 inches. Four corners 42 of the child safe break resistant reflective surface 40 being rounded. An adhesive material such as hook and loop type material is mounted along a perimeter 48 of the child safe break resistant reflective surface 40. This adhesive material is used to non-permanently attach an attachable/detachable fabric frame cover 45 to the child safe break resistant reflective surface 40. The attachable/detachable fabric frame cover 45 overlaps the perimeter 48 of the child safe break resistant reflective surface 40. The attachable/detachable frame cover 45 attaches to the child safe reflective surface 40 using a mating loop and hook material

The attachable/detachable fabric frame cover 45 has an outer dimension equal to the child safe break resistant reflective surface 40. The attachable/detachable fabric frame cover 45 has an outer width Wo of at least seven inches and has an outer height Ho of at least six inches. The attachable/detachable fabric frame cover 45 has an inner height Hi of at most 5¼ inches and has an inner width of at most six inches. The attachable/detachable fabric frame cover 45 being made in a variety of fabrics and patterns including but not limited to corduroy, fake fur, patterned materials in black, white, primary and secondary colors, and chenille. The attachable/detachable fabric frame cover 45 is filled with a batting type material to soften the edges of the frames for safety. The attachable/detachable fabric frame cover 45 are interchangeable and are attached to the perimeter 48 using a hook and loop material, ribbon, or some other securing material, to the mirror border.

In another embodiment, a solid black attachable/detachable frame provides a canvass to focus the infant's attention to attachable/detachable rattles (FIG. 17, FIG. 18, and FIG. 19). The solid black attachable/detachable frame completely overlaps the child safe break resistant reflective surface 40, having a height of at least six inches, having a width of at least seven inches, four rounded corners, and four fabric loops to secure the attachable/detachable rattles of FIG. 17, FIG. 18, and FIG. 19.

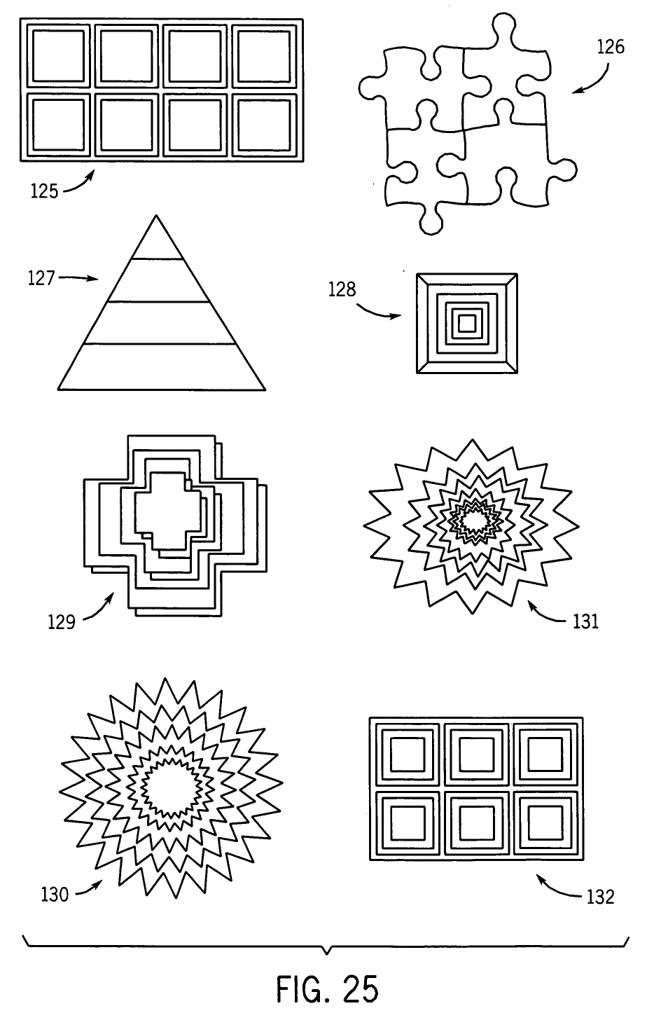

In another embodiment, a vinyl pocket attachable/detachable frame provides a protective area to house a page of the configurable cloth book FIG. 4 or a pattern sheet FIG. 25. The vinyl pocket attachable/detachable frame completely overlaps the child safe break resistant reflective surface 40, having a height of at least six inches, having a width of at least seven inches, four rounded corners, and a transparent vinyl pocket. The transparent vinyl pocket having an outer height one half inch less than the height of the reflective surface and a width less than the width of the reflective surface.

FIG. 11 is a side view of the child safe break resistant reflective surface 40. An accordion pleated back 55 used in conjunction with a weighted base 51 keeps the child safe break resistant reflective surface 40 at any angle inclusive of 0 degrees to 180 degrees. A attachable/detachable fabric frame cover 45 envelops the child safe break resistant reflective surface.

FIG. 12 is a back view of the child safe break resistant reflective surface 40 of FIG. 10. An accordion pleated back 55 used in conjunction with a weighted base 51 keeps the child safe break resistant reflective surface 40 of FIG. 10 at any angle inclusive of 0 degrees to 180 degrees. The accordion pleated back 55 is a rigid material included but not limited to plastic and stiff fabrics. The accordion pleated back 55 is fan-folded to accommodate opening, closing, or positioning the child safe break resistant reflective surface 40 of FIG. 10 to any angle including 0 degrees to 180 degrees. At least four securing loops 52 are permanently attached to the accordion pleated back 55. These at least four securing loops 52 are used to suspend the child safe break resistant reflective surface 40 such that the infant can see himself and to provide a securing loop for an attachable/detachable rattle (FIG. 17, FIG. 18, and FIG. 19).

In one embodiment the weighted base 51 is a series of several small weights.

In another embodiment the weighted base 51 has a closing mechanism 59 including such materials as a hook and loop material, ribbon, or some other securing device, which will allow for the mirror to be closed and locked into a flat position

Associated with the child safe break resistant reflective surface is an activity page, like that shown in FIG. 26. The activity page contains a descriptive title, which associates the page with the child safe break resistant reflective surface. The content of the activity page contains three main sections: (i)) a list of fun and developmentally appropriate activities associated with the child safe break resistant reflective surface, (ii) information regarding the important role the child safe break resistant reflective surface has on development and the developmental skills being addressed, and (iii) safety warnings, developmental milestones, and other information relevant to the child safe break resistant reflective surface.

Exemplary text for the child safe break resistant reflective surface's activity page follows.

Child Safe Break Resistant Reflective Surface Card
1. Lay your baby on their back on the stay in place mat, floor, crib, or pack and play. Place the mirror to the right or left of her head. Adjust the mirror to the right angle so that she can see her face in the mirror. Encourage your child to turn her head by talking in a higher pitched voice, making silly noises, etc. behind the mirror. Once she can see herself in the mirror continue to talk to her and describe what she sees in the mirror. For example, “Look at Sally in the mirror. Oh, she has such big eyes. Look at that cute nose.” (0-4 months)
2. Place your baby on her tummy on a blanket on the floor. Place the mirror in front of the baby's head. Adjust the angle of the mirror so the baby when lifting her head can see herself in the mirror. Encourage your baby to lift her head by using the star rattle to look up at until she can catch a glimpse of herself in the mirror. Praise her for any attempt to lift up her head. If she does see herself, talk about her facial features that she sees in their mirror. (0-4 months)
3. Use the mirror to hang over your baby while she lies on her back on the stay in place mat or under a jungle gym. Use the back securing loops to attach the mirror to the rings and then to the gym. (0-5 months)
4. Change the borders of the mirror every few days. (0-5 months)
5. Sit with your baby on your lap resting her back on your chest. Have the mirror on your lap and smile and coo at the mirror. Describe what you see. “I see Daddy and Sally in the mirror. Look at Daddy kiss Sally on her head.” (2-6 months and beyond)
6. With your child on your lap, take your baby's hand and help her reach for the borders of the mirror. Allow her to experience the different fabric borders. (1-6 months)
7. Place a small blanket over the mirror when the child can definitely see herself and play a peek a boo game with her. (3-6 months and beyond)

Safety::
Do not leave your baby alone with any of these objects to play with.
This is a supervised play activity only.

These activities are intended to emphasize development in gross motor skills, self recognition, sensory, language skills, and the infant's ability to fixate on an object. By encouraging the infant to focus on their face, this helps in the early development of self recognition. The activities provided for the caregiver allow them to use the interchangeable frames of the mirror which helps to encourage the infant to focus on the mirror by providing the infant with bold, striking patterns that infants can typically see at this stage of development. The clear vinyl frame will allow for caregivers to use the pattern cards provided with the kit to use the toys in combination. The hooks on the mirror give the option for the caregiver to use one of the many rattles in combination with the black interchangeable frame as a method for propping up an item for better line of sight for the infant. The mirror's ability to hang from an activity gym allows the infant to work on gross motor abilities through reaching or kicking for the mirror. By following the activities that place the infant on their stomach, and adjusting the mirror accordingly to the infant's size and height, the infant is able to view themselves in the mirror while strengthening their shoulder girdle and neck muscles. The detachable frames have tactile fabrics allowing the infant to explore different sensory experiences through touching the fabric frames. By providing the caregiver with ideas for finger plays, word games, or suggested dialog with their infant, they are encouraging the early building blocks for language development.

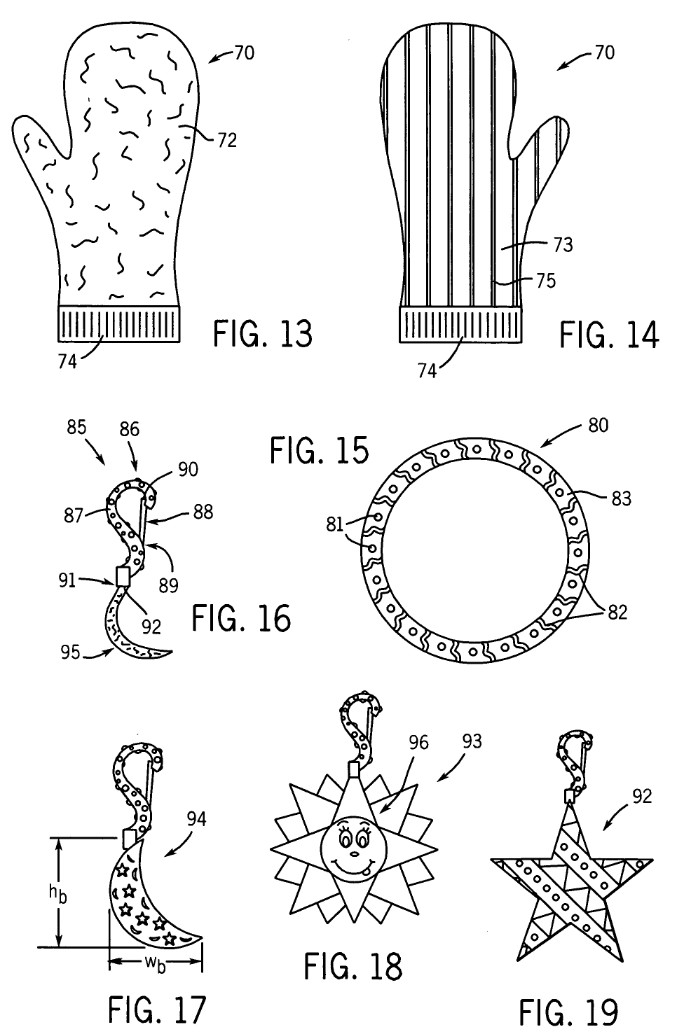

FIG. 13 is a front view of a sensory mitten 70. The purpose of the sensory mitten 70 is for the caregiver to provide tactile stimulation to the infant similar to infant massage. In addition, the sensory mitten 70 is used for other activities as well including, but not limited to tracking and reaching. The sensory mitten 70 is covered in textured materials 72 include but not be limited to fake fur, velour, or yarn.

In one embodiment the sensory mitten 70 is at least the sizes of small, medium, and large.

In another embodiment, the sensory mitten 70 is a one size fits all.

In a non-limiting example, FIG. 13 shows a sizing mechanism 74 integrated to the cuff of the sensory mitten 70. The purpose of the sizing mechanism 74 provides a means to secure the sensory mitten 70 onto varying size hands. The sizing mechanism 74 includes but is not limited to elastic.

FIG. 14 is a back side of the sensory mitten 70. In a non-limiting example, FIG. 11 shows textured materials 73 on the back side of the sensory mitten different than the textured materials 72 of FIG. 13 on the front side of the sensory mitten. The textured materials 73 of the back side of the sensory mitten include but are not limited to fake fur, chenille, velour, or yarn.

Associated with the sensory mitten is an activity page, like that shown in FIG. 26. The activity page contains a descriptive title, which associates the page with the sensory mitten. The content of the activity page contains three main sections (i) a list of fin and developmentally appropriate activities associated with the sensory mitten, (ii) information regarding the important role the sensory mitten has on development and the developmental skills being addressed, and (iii) safety warnings, developmental milestones, and other information relevant to the sensory mitten.

Exemplary text for the sensory mitten's activity page follows:

### Sensory Mitten Activity Card

1. Lay your baby on a blanket on the floor, pack and play or changing table. Take one of their shirt, pants, or socks off depending on the season. With your baby in a quiet alert state, use the mitten on your hand to gently stroke downward on a part of their body (arms, legs, belly, neck, head, back, and face). Make sure you go very slow and touch gently, so as to not cause a startle response. Do this gradually over the front and back side of their body. Talk to your baby while you do this and tell them, “Mommy is touching your arm. This feels smooth, soft, etc.” (0-6 months and beyond)
2. If your baby does not tolerate being undressed or if the season does not permit for your child to have their clothes off for an extended period of time, do this activity while they are getting their diaper changed. Once they are clean, use the mitten to gently stroke their legs and lower belly. You can also gently stroke their head and neck area. (0-6 months and beyond)
3. Using just the finger of the mitten, gently massage your baby. (0-6 months and beyond) *Don't rub or massage the tummy area until the umbilical cord has healed completely.
4. Give the mitten to your child to manipulate on their own. (4-6 months and beyond)

### Safety::

Do not leave your baby alone with any of these objects to play with.
This is a supervised play activity only.

The activities provided with the sensory mitten are intended to emphasize development in sensory, self recognition, and language skill development. The sensory mitten provides tactile stimuli appropriate for their developmental level. The mitten encourages the infant to engage in play with the toy, also stimulating the infant visually and encouraging gross motor, and hand eye coordination skills (i.e., reaching and tracking). Caregiver communication with the infant while using the sensory mitten provides the child opportunities to engage in language (by turn taking with sounds, caregivers talking to the child, etc.).

FIG. 15 is a front view of a circular ring rattle 80. The circular ring rattle 80 is made of a textured plastic 83 material and is at least four inches in diameter. The textured plastic material includes but is not limited to sensory bumps 81 or sensory grooves 82, and includes protruding corrugated piping or swirls. The circular ring rattle 80 is at least one of the colors black, white, or red. The circular ring rattle 80 can be used alone for grasping and tracking activities, or in combination with attachable/detachable rattles (FIG. 17, FIG. 18, and FIG. 19).

Associated with the circular ring rattle and the attachable/detachable rattles is an activity page, like that shown in FIG. 26. The activity page contains a descriptive title, which associates the page with the circular ring rattle and the attachable/detachable rattles. The content of the activity page contains three main sections: (i) a list of fun and developmentally appropriate activities associated with the circular ring rattle and attachable/detachable rattles, (ii) information regarding the important role the circular ring rattle and attachable/detachable rattles has on development and the developmental skills being addressed, and (iii) safety warnings, developmental milestones, and other information relevant to the circular ring rattle and attachable/detachable rattles.

Exemplary text for the circular ring rattle's activity page follows:

Circular Ring Rattle and Attachable/Detachable Rattles Activity Card
1. Place baby in your lap. Detach one of the attachable/detachable rattles from circular ring rattle and use this item to hold over your baby. (Approximately 8-10 inches) Move this item side to side slowly and allow their eye movements to catch up. (0-2 months)
2. Describe the item you have in your hand to your baby. Talk about the colors, shapes, size, textures, smells and sounds to them. “Look at the red, white and black star.” “Look how little the moon is.” “Did you hear that bell?” (0-6 months and beyond)
3. Take one of the attachable/detachable rattles from the circular ring rattle and place it on their jungle gym. Place your baby under the hanging rattle. Move their hands to the rattle to make it swing. Describe what you are doing. “Look, Sammy's hands can touch the rattle.” (0-5 months)
4. Lay your baby on your lap. Take one of the attachable/detachable rattles and open your baby's fist. Place this rattle in their hand and have them shake the rattle. (2-6 months)
5. Use the circular ring rattle and place two of the attachable/detachable rattles on the ring. Have your baby manipulate the objects in their hands. (3 months and beyond)
6. Give the entire circular ring rattle and associated attachable/detachable rattles for them to hold and manipulate. Allow them to discover things on their own. (5 months and beyond)

Safety Warning

This is not a diagnostic tool. If the caregiver is concerned about the child's development, hearing, etc. the child's pediatrician should be notified immediately.

All children develop differently and if your child is unable to do any activity during a suggested time period, it does not mean that your child has a delay. If you have concerns regarding your child's development, you may choose to contact your child's pediatrician.

These activities are not intended to be used as a diagnostic tool in any way.

### Importance and Development

These activities are intended to emphasize development in auditory, visual discrimination, sensory, and motor skills.

These activities listed in the activity cards are intended to emphasize the infant's the ability to visually discriminate objects in their environment. Infants initially are attracted to bold complex patterns and typically can see best the colors of black, white, and red due to poor color vision and retinal immaturity. As the infant gets older, they are capable of seeing a broader spectrum of colors. The activities included with the plastic rattles, correspond with the typical age ranges that infants are expected to see these different colors. The rattles provided with the activities will easily capture their attention through the use of colors and high contrasting patterns. Each rattle is provided with a different auditory device. When participating with a caregiver, the infant will have the advantages of hearing different auditory stimuli of chimes, bells, and beads to encourage their auditory abilities and concentration on one auditory stimulus. Each rattle has a unique tactile surface which will allow the infant to explore and gain new sensory experiences. The rattle's features provide the infant with ease of handling, and the ability to be attachable/detachable to play gyms, stay in place mat, accordion mirror, strollers, and car seats, the caregiver can vary the activities to suit their child's needs. Since there are many options of use with the attachable/detachable rattles, the infant is provided with numerous options for auditory and tactile experiences.

FIG. 16 shows a front view of an attachable/detachable rattle 85. The attachable/detachable rattle 85 has a securing device 86 and a main body 95. In a non-limiting example FIG. 16 shows the main body 95 in the shape of a moon. The main body 95 has a height Hb of at least one inch, a width Wb of at lest one inch, and a depth Db of at least one inch. The main body 95 can be in the shapes including but not limited to a moon, a sun, and a star.

A top portion of the main body 91 is joined to the base of the securing device 86. The securing device 86 is made from a hard plastic having sensory bumps 87. A retractable tab 88 is joined to a bottom location 89 to the securing device 86, and remains at resting state in a closed position at a top location 90 of the securing device 86. The securing device 86 provides a mechanism to attach/detach the attachable/detachable rattle 85 to another object such as but not limited to the circular rattle 80 in FIG. 15. The attachable/detachable rattle 85 is configured to be used as a stand alone item, in conjunction with the plastic circular rattle 80, or in conjunction with other user provided objects such as but not limited to stroller straps, activity gyms, activity rings, and bouncy seat straps.

In one embodiment the main body 95 include an auditory device including but not limited to bells, beads, or chimes.

In another embodiment the main body includes a fragrance including but not limited to vanilla, cinnamon, or lilac.

FIG. 17 is a non-limiting illustration of the main body 95 of FIG. 16 in the shape of a moon 94. The shape of the moon 94 is covered in at least a pattern, facial expression, or graphic design. The moon has a texture that can beat least a ribbed, bumps, swirls, or grooves. The shape of the moon 94 is in at least the colors of black, white, primary colors, and secondary colors.

FIG. 18 is a non-limiting illustration of the main body 95 of FIG. 16 in the shape of a sun 93. The shape of the sun 93 being a sunburst.

In one embodiment, the shape of the sun 93 having a facial expression.

In another embodiment, each sunray 96 of the shape of the sun 93 being of a different color.

FIG. 19 is a non-limiting illustration of the main body 95 of FIG. 16 in the shape of a star 92. The shape of the star 92 being in the colors of black, white, primary colors, and secondary colors. A pattern on the shape of a star 92 having additional shapes such as but not limited to stars or graphic design.

The activity page associated with each attachable/detachable rattle is the activity page for the Circular Ring Rattle as discussed above.

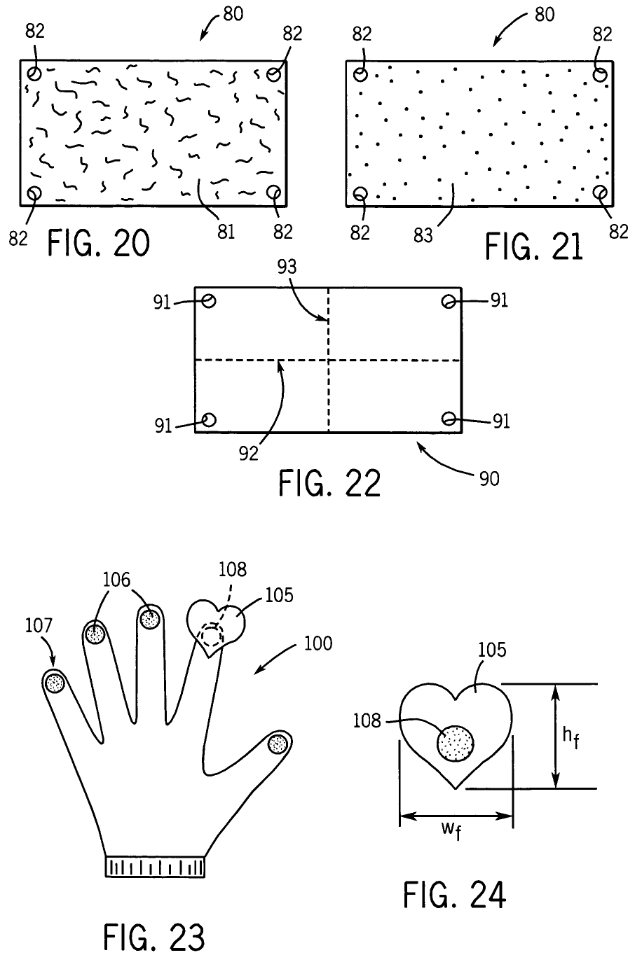

FIG. 20 is a front view of a sensory mat 80. A textured material 81 includes but is not limited to fake fur, chenille, velour, or yarn. The infant lies on the sensory mat 80 and acquires sensory stimulation while relaxed and or engaged in an activity.

The sensory mat 80 is used alone or with the stay-in-place mat 90 of FIG. 22. The sensory mat 80 is stitched to fit snuggly over the stay-in-place mat 90 of FIG. 22.

In another embodiment the sensory mat 80 has at least four securing devices 82 are located in each of four corners of the sensory mat 80. The at least four securing devices 82 mate with the at least four receiving securing devices 91 of the stay in place mat 90 of FIG. 22.

In another embodiment, the sensory mat 80 is secured to a non-flexible surface to prevent the sensory mat 80 in place.

In another embodiment, the sensory mat 80 has a rubberized undersurface to keep the sensory mat 80 in place.

FIG. 21 is a back view of the sensory mat 80 made from a textured material 83 to include but not limited to one of fake fur, chenille, velour, or yarn. The textured material 83 is different than the textured material 81 of FIG. 20. At least four securing devices 82 are located in each of four corners of the sensory mat 80. The at least four securing devices 82 mate with the at least four receiving securing devices 91 of the stay in place mat 90 of FIG. 22.

Associated with the sensory mat is an activity page, like that shown in FIG. 26. The activity page contains a descriptive title, which associates the page with the sensory mat. The content of the activity page contains three main sections:: (i) a list of fun and developmentally appropriate activities associated with the sensory mat, (ii) information regarding the important role the sensory mat has on development and the developmental skills being addressed, and (iii) safety warnings, developmental milestones, and other information relevant to the sensory mat.

Exemplary text for the sensory mat activity page follows:

### Sensory Mat Activity Card

Activity Ideas:
1. Place the sensory mat on the stay in place mat, on the floor or pack and play. Choose a very soft fabric to use for the first time. Lay your baby on their stomach on the mat which will allow them to work on raising their head. *Please be sure to be next to your newborn when doing this activity. It is important that they can breath and do not smother their face into the fabric. This activity is very important for your child to strengthen their neck, back, and shoulder muscles. Follow your pediatrician's advice for tummy time recommendations. Place one of the black and white patterns in your hand and hold it to the side of their face and encourage your baby to lift their head to look at the pattern. Reinforce any movements they make by saying, “Good job”, “Look at daddy's baby, he's lifting his head”, and talking in a higher pitched voice. (0-3 months)
2. Change out the fabrics every few days, so the baby can have the ability to discover new sensations through touching each different fabric. (0-6 months and beyond)
3. You can place the stay in place mat with fabric under their jungle gym while they are lying on their backs looking up at a rattle or the book mobile, just for added stimulation. (0-5 months)
4. Give your child a sensory mat to manipulate on their own. Describe the fabric to them as they hold it in their hands. Describe the color, texture, etc. “Oh, look, feel how soft this blanket is.” (4-6 months and beyond)

Safety:
Do not leave your baby alone with any of these objects to play with.
This is supervised play activities only.
Make sure to pay attention for any signs of your child getting over stimulated, i.e. crying.

FIG. 22 is a front view of a stay-in-place mat 90. The stay-in-place mat is a collapsible, waterproof board made from but not limited to plastic, vinyl, cardboard covered in a waterproof coating, and a stiff fabric covered in a waterproof coating. The stay-in-place mat 90 is perforated in a vertical direction 93 and is perforated in a horizontal direction 92 so that the stay-in-place mat 90 is easily collapsible. At least four receiving securing devices 91 are located in each of four corners of the stay-in-place mat 90. These at least four receiving securing devices 91 match up with the securing devices 82 of FIG. 20 and FIG. 21 to keep the sensory mat 80 in place while providing a sturdy surface for the infant to lie upon. The at least four receiving securing devices 91 are not limited to hook and loop fabric, snaps, and zippers.

In another embodiment, the stay in place mat 90 has a cloth loop adjacent to each of the at least four receiving securing devices 91. The cloth loop provides an area to attach the toys associated with this invention including but not limited to the cloth rattle (FIG. 1), the cloth book mobile (FIG. 4), the child safe reflective surface (FIG. 10), and the attachable/detachable rattles (FIG. 17, FIG. 18, and FIG. 19). The infant is able to play with the toys while experiencing sensory stimulation of the stay in place mat 90.

In another embodiment, the stay in place mat 90, has a transparent waterproof pocket covering a width equal to the width of the stay in place mat 90 and a height equal to one third the height of the stay in place mat. The pocket houses pages of the cloth book (FIG. 4), activity cards (FIG. 26), and Pattern Sheets (FIG. 25).

Associated with the stay-in-place mat 90 is an activity page, like that shown in FIG. 26. The activity page contains a descriptive title, which associates the page with the stay-in-place mat 90. The content of the activity page contains three main sections (i) a list of fun and developmentally appropriate activities associated with the stay-in-place mat, (ii) information regarding the important role the stay-in-place mat has on development and the developmental skills being addressed, and (iii) safety warnings, developmental milestones, and other information relevant to the stay-in-place mat.

Exemplary text for the stay-in-place mat activity page follows:

### Stay in Place Mat Activity Card

1. Place the mat on the floor. Attach one of the pages of the face book to the center top hook of the mat. Place your newborn on his stomach approximately 6 inches from the page. Describe the page to the infant. Encourage them to touch the face. (0-3 months)
2. Place the mat on the floor. Attach the cloth rattle on the center top hook of the mat. Attach a page from the face book on both top corner hooks. Allow your newborn to explore the rattle and book pages while placing him on his stomach. (0-4 months)
3. Place the mat on the floor. Attach a plastic rattle on both of the top corner hooks. Lie your baby down on the mat on his back. Take one of his arms and pull it gently across his body until he in on his side. Encourage him to touch and/or reach for the rattles. Do this to both sides. (3-6 months and beyond)
4. Place the mat on the floor. Attach a rattle, book from the face page, or plastic rattle, to all corners of the mat. Allow your baby to roll over to explore them, or place him on his stomach to encourage him to raise his heads. (3-6 months and beyond)

Saftey:
Do not leave your child unattended during these activities

The activities provided with the stay in place emphasize development for infants in gross and fine motor, visual discrimination, and language skills.

The activities provided with the stay in place mat encourage caregivers to place the infant on his stomach to promote the strengthening of the neck and shoulder girdle muscles. The mat is to be used in combination with the pattern cards. Place the pattern card in the vinyl sleeve in which the infant will be able to view them while on his stomach. Since infants are initially attracted to the colors of black, white, and red due to retinal immaturity, the infants will be provided with visual stimuli appropriate for their developmental level. The hooks provided with the mat provide the caregiver with options for placement of the plastic rattles, cloth rattle, or the pages of the books. These options for placement will help encourage the infant to engage in play with the toys, thereby encouraging fine and gross motor, and hand eye coordination skills (i.e., reaching, rolling, and strengthening back and neck muscles). Caregiver communication with the infant while they are on the mats provides the child opportunities to engage in language (by turn taking with sounds, caregivers talking to the child, etc.).

FIG. 23 is a front view of a visual glove 100. The visual glove 100 is black and has securing points 106 on each tip 107 of the glove. The securing points 106 are not limited to hook and loop fabric, yarn, or snaps. At least five finger objects 105 having correlating securing points 108 to the visual glove 100 securing points 106.

FIG. 24 is the back view of one of the at least five finger objects 105. The at least five finger objects 105 are at least one of black, white, red, green, yellow, blue, orange, and purple. The at least five finger objects 105 are made from but not limited to fur or yarn. The at least five finger objects 105 are made in a variety of patterns including but not limited to shapes, objects, animals, people, or ambiguous patterns. The at least five finger objects 105 have a height Hf of at least one inch and a width Wf of at least one inch.

The at least five finger objects 105 are attached to the visual glove 100 of FIG. 23 at the securing points 108 using but not limited to hook and loop fabric, yarn, and snaps.

In one embodiment, the at least five finger objects 105 include objects that make sound, including but not limited to bells and crinkly fabrics.

The visual glove 100 is designed for caregivers to wear on one of their hands. The finger objects are designed to be removed and attached to the fingers of the glove using a hook and loop material. A caregiver chooses to place one object on their finger, multiple objects on various fingers, up to five objects to cover every finger.

The visual glove 100 is designed to help caregivers play fun visual tracking games, sing silly finger songs, and help the baby work on reaching skills. The visual glove is a one size fits all.

In another embodiment, the visual glove 100 comes in the sizes small, medium, large

In another embodiment, the visual glove 100 has an adjustable securing device accommodating users of various sizes.

Associated with the visual glove 100 is an activity page, like that shown in FIG. 26. The activity page contains a descriptive title, which associates the page with the visual glove 100. The content of the activity page contains three main sections: i) a list of fun and developmentally appropriate activities associated with the visual glove, (ii) information regarding the important role the visual glove has on development and the developmental skills being addressed, and (iii) safety warnings, developmental milestones, and other information relevant to the visual glove.

Exemplary text for the visual glove's activity page follows:

### Visual Glove Activity Card

### Activities:

1. Place the black glove on your hand and have your baby in your lap. Have your hand about 8 to 12 inches from the baby's face and allow your baby to focus on the glove by wiggling your fingers around slowly. Open and close your hand like waving goodbye and also make a fist then open it slowly. (0-2 months)
2. Place one object on a finger. Allow your baby to focus on that finger and slowly move the finger closer to the baby then far away. Do this several times to practice their tracking abilities. (0-2 months)
3. Move your finger with an object from one side of their head to the other to practice their head righting abilities. (0-2 months)
4. As your child gets older (1 month), add two objects at a time and wiggle your fingers. Make sure to describe what you see by saying, “Look at the black and white ball, it is small.”
5. As your child gets older add more objects to your fingers and increase your movements. Make your movements a little faster and begin to expand your movements by bringing the objects a little farther away from your child. (3 months and beyond).
6. Bring your baby's hand toward the objects to touch them. (3 months and beyond)
7. Sing songs while you have the objects on your hand. If the object is a ball, you can sing, “Jingle bells” and replace all the words with ball. Sing “Twinkle Twinkle” for the star, “You are my sunshine.” (0-6 months)

Safety::
Do not leave your baby alone with any of these objects to play with.
This is a supervised play activity only.
Do not allow your baby to put the finger objects in their mouth.

FIG. 25 is a front view of a pattern sheet 125, designed for caregivers to provide a visually stimulating activity for their baby. The Pattern sheet 125 is made from a durable material to include but not limited to paper, card stock, or cardboard. The pattern sheet 125 has a visually stimulating graphic pattern on at least a front side of the pattern sheet 125 which is appropriate for newborns and young babies. A back side of the pattern sheet is either a solid color or has a pattern different than the pattern on at least the front side of the pattern sheet. The pattern sheet 125 includes at least the colors black, white, and red. The pattern sheet 125 is at least six inches by six inches and is not limited to the shapes of a square, rectangle, and circle. The pattern sheet 125 is configured to be divided into sections that can easily be separated for activity use.

In one embodiment, the patter sheet 125 is three dimensional; including raised textured surfaces over the graphical patterns associated with the pattern sheet.

In another embodiment the pattern sheet 125 has attachable/detachable pieces.

In a non-limiting example, FIG. 25 illustrate a puzzle pattern 126, a pyramid pattern 127, a concentric square pattern 128, a concentric cross pattern 129, a concentric star burst pattern 130, a concentric squashed star pattern 131, and a multiple concentric square pattern 132.

Associated with the pattern sheet 125 is an activity page, like that shown in FIG. 26. The activity page contains a descriptive title, which associates the page with the pattern sheet 125. The content of the activity page contains three main sections: (i) a list of fun and developmentally appropriate activities associated with the pattern sheet, (ii) information regarding the important role the pattern sheet has on development and the developmental skills being addressed, and (iii) safety warnings, developmental milestones, and other information relevant to the pattern sheet.

Exemplary text for the pattern sheet's activity page follows:

Pattern Sheet Activity Card

Activities:
1. Place your child on a blanket on the floor on their backs. Place the pattern sheet into the vinyl pocket of the break resistant reflective surface pocket frame or prop the individual pattern sheet onto the base of furniture. Allow your child to turn their heads toward the pattern to practice moving their heads to one side. (0-2 months)
2. Place the pattern sheets upright, next to their changing area for the baby to look at while being changed. (0-6 months and beyond)
3. With your baby in your lap, sitting in a bouncy seat, high chair, stroller, carrier, etc. hold the pictures in front of them. approximately 8-10 inches. Move the pattern slowly to one side, back to the middle, and to the other side. Make sure you do this very slowly and allow their eye movements to catch up with your movement of the page. This will help your baby practice on focusing, visual discrimination, and tracking skills. (0-3 months)
4. Place one of the cards in the stay in place mat pocket. Allow your child to be on their tummy during this activity. Let them explore the card. (1-6 months)
5. Place one of the cards in the vinyl frame of the mirror. Place your child on their tummy to explore the pattern card. (1-6 months)
6. With your baby in your lap, with their backs resting against your chest, take one of the textured cards and allow your baby to feel the new textures by taking their hands to the cards. Describe the color, shape, and texture of the pattern card. (3-6 months)

Safety
Please do not leave your baby alone with any of these objects to play with.
This is supervised play activities only.
Gage the temperament of your baby during these activities as to not over stimulate them visually

Additional activity pages contain developmentally appropriate activities combining the use of more than one toy according to an aspect of the present invention. The content of the activity page contains three main sections: (i) a list of fun and developmentally appropriate activities associated with the pattern sheet, (ii) information regarding the important role the pattern sheet has on development and the developmental skills being addressed, and (iii) safety warnings, developmental milestones, and other information relevant to the pattern sheet.

An example of a combination activity page follows.

Combination Toy Activity Card

Toys:
1. Sensory Mat
2. Pattern Sheet
3. Break resistant reflective surface
4. Break resistant reflective surface attachable/detachable vinyl pocket frame
5. Break resistant reflective surface attachable/detachable solid black frame
6. Cloth Book Mobile

Activities:
1. Place your child on the sensory mat or on a blanket on the floor on their backs. Place the pattern sheet into the vinyl pocket of the break resistant reflective surface pocket frame. Use the visual pattern cards with the clear vinyl frame of the mirror. The pattern cards can also be used with vinyl pocket on the stay in place mat. (4-6 months and beyond)
2. Use the pages of the face book to attach to the stay in place mat. (4 months and beyond)
3. Use one of the pages of the face book and attach to the hook on the center of the break resistant reflective surface. Please make sure to use with the black frame of the mirror. (3-6 months and beyond)
4. Take one of the plastic rattles and attach to the center hook on the break resistant reflective surface. Make sure the black frame is on the break resistant reflective surface. (3-6 months and beyond)
5. Take three of the plastic rattles and attach to each side of the stay in place mat and one for the center of the mat. (0-5 months and beyond)
6. Take all the pages of the face book and attach to all of the hooks on the stay in place mat. (2-6 months and beyond)

Safety
Do not leave your baby alone with any of these objects to play with.
This is supervised play activities only.

FIG. 26 is a front view of an activity page 150 according to an aspect of the present invention. The activity page contains a descriptive title 151, which associates the page with a specific toy in the toy set. The content of the activity page contains a descriptive title associating the page with a specific toy 151, (i) a list of at least four fun and developmentally appropriate activities associated with the toy 153, (ii) information regarding the importance the role of the toy has on development and the developmental skills the toy is addressing 152, and (iii) safety warnings, developmental milestones, and other information relevant to the toy, child, and caregiver. A company logo 155 is included on the activity page.

Additional activity pages contain developmentally appropriate activities associated with more than one toy according to an aspect of the present invention.

We claim:

1. A portable early learning sensory system comprising:
a tactile learning component configured to stimulate a tactile response by the child;
a first caregiver assistance guide configured to provide an explanation to a caregiver regarding how to use the tactile learning component with the child to stimulate the tactile response of the child, said first caregiver assistance guide also including a first progression monitoring component that describes objective metrics by which the caregiver can compare an observed activity of the child with the tactile learning device against predetermined standards;
a visual learning component configured to stimulate a visual response by the child;
a second caregiver assistance guide configured to provide an explanation to the caregiver regarding how to use the visual learning component with the child to stimulate the visual response of the child, said second caregiver assistance guide also including a second progression monitoring component that describes objective metrics by which the caregiver can compare the observed activity of the child with the visual learning device against predetermined standards;
an auditory learning component configured to stimulate an auditory response by the child;
a third caregiver assistance guide configured to provide an explanation to the caregiver regarding how to use the auditory learning component with the child to stimulate the auditory response of the child, said third caregiver assistance guide also including a third progression monitoring component that describes objective metrics by which the caregiver can compare the observed activity of the child with the auditory learning device against predetermined standards; and
a portable enclosure configured to house the tactile leaning component, the visual learning component, the auditory learning component, the first caregiver assistance guide, the second caregiver assistance, and the third caregiver guide contained therein.

2. The system of claim 1, wherein said tactile learning component includes at least one of an object having different textures and different shapes.

3. The system of claim 1, wherein said tactile learning component includes an item having a surface, a first portion of said surface having a first portion that has a distinct surface height contrast with a second portion of the surface.

4. The system of claim 1, wherein said tactile learning component also includes a fragrance.

5. The system of claim 1, wherein said visual learning component includes at least one of an object having different contrasts, different colors, different emotions, and different shapes.

6. The system of claim 1, wherein said visual learning component includes an object having a surface, a first portion of said surface having a first portion that has a different grayscale contrast than a second portion of the surface.

7. The system of claim 1, wherein said visual leaning component includes an object having a surface, a first portion of said surface having a different color contrast than an at least one other portion of said surface, wherein the color being one of a primary color, a secondary color, a tertiary color, or a pastel color.

8. The system of claim 1, wherein said visual leaning component includes an item displaying a predetermined human emotion expressed on an image of a face.

9. The system of claim 1, wherein said visual learning component includes an item displaying a predetermined geometric pattern.

10. The system of claim 1, wherein said auditory learning component includes different objects that emit different sounds.

11. A method for stimulating early learning for a child, comprising the steps of:
placing a tactile learning component within reach of the child;
reviewing an informational component of a first caregiver assistance guide that instructs the caregiver on how to use the tactile educational component to encourage a tactile sensory development of the child;
observing an interaction by the child with the tactile learning component;
comparing a result of the observing step with an objective standard provided by the first caregiver assistance guide so as to determine a level of educational development of the child via interaction with the tactile learning component;
placing a visual learning component within view of the child;
reviewing an informational component of a second caregiver assistance guide that instructs the caregiver on how to use the visual learning component to encourage a visual sensory development of the child;
observing an interaction by the child with the visual learning component;
comparing a result of the observing step with an objective standard provided by the second caregiver assistance guide so as to determine a level of educational development of the child via interaction with the visual learning component;
placing an auditory learning component within hearing range of the child;
reviewing an informational component of a third caregiver assistance guide that instructs the caregiver on how to use the auditory learning component to encourage an auditory sensory development of the child;
observing an interaction by the child with the auditory learning component;
comparing a result of the observing step with an objective standard provided by the third caregiver assistance guide so as to determine a level of educational development of the child via interaction with the auditory learning component; and
placing the tactile learning component, the visual learning component, the auditory learning component, the first caregiver assistance guide, the second caregiver assistance guide, and the third caregiver assistance guide in a portable enclosure.
